(19) United States
(12) Patent Application Publication
(10) Pub. No.: US 2025/0226945 A1
(43) Pub. Date: Jul. 10, 2025

(54) OPTIMIZATION OF MAPPING AND DEMAPPING FOR WIRELESS COMMUNICATION CHANNELS

(71) Applicant: Hughes Network Systems, LLC, Germantown, MD (US)

(72) Inventor: Neal D. Becker, Frederick, MD (US)

(21) Appl. No.: 19/013,222

(22) Filed: Jan. 8, 2025

Related U.S. Application Data
(60) Provisional application No. 63/618,749, filed on Jan. 8, 2024.

(51) Int. Cl. H04L 5/00; H04L 25/02; H04L 25/49

(52) U.S. Cl. CPC H04L 5/0048; H04L 25/0254; H04L 25/4921

(57) ABSTRACT

Methods, systems, and apparatus, including computer programs encoded on computer-storage media, for optimization of mapping and demapping for wireless communication channels. In some implementations, a transmitter includes a mapper that has been trained through machine learning training. The transmitter is trained based at least in part on demapper characteristics for a demapper of a receiver. The mapper has parameter values that have been trained to at least partially compensate for non-linear distortion of signals in a wireless communication channel, including through application of non-linear distortion during training. The mapper is configured to map data to be transmitted to symbols in a symbol constellation for transmission. The parameter values of the mapper define characteristics of the symbol constellation including amplitude or phase of the symbols in the symbol constellation.

### CROSS-REFERENCE TO RELATED APPLICATIONS

This application claims the benefit of priority to U.S. Provisional Patent Application No. 63/618,749, filed on Jan. 8, 2024, the entire contents of which is incorporated by reference herein.

### BACKGROUND

The present specification relates to techniques for wireless communication, including improved mapping and demapping for nonlinear wireless channels.

In wireless communication systems, such as satellite networks, a transmitter often performs mapping to translate data to be transmitted to symbols in a constellation. Different points in the constellation can represent different combinations of amplitude or phase, so each symbol represents a different bit sequence. The receiver detects transmitted signals and performs demapping to determine which symbols were transmitted, so the bit sequences can be accurately recovered by the receiver. In some cases, the characteristics of amplifiers and other hardware in the system and the operating constraints on the system result in nonlinearities that make accurate reception more difficult.

### SUMMARY

In some implementations, a system uses optimization techniques to improve mapping and demapping for wireless communication channels. This can increase capacity, improve accuracy of reception, and improve power efficiency for wireless communications. For example, a mapper and demapper can be jointly optimized to compensate for nonlinearities in the communication channel, such as non-linearity of a satellite's high power amplifier. Machine learning techniques can be used to adjust symbol constellations jointly with demapping techniques. For example, characteristics of a symbol constellation can be adjusted, such as by shaping the constellation to adjust the locations of the symbols in the constellation and/or adjusting the bit sequences that each symbol represents. In some implementations, a demapper can include a neural network that is trained to demap symbols for the optimized constellation, e.g., to generate bit log-likelihood ratios (LLR) for input to an forward error correction (FEC) decoder.

In many satellite systems, on the forward communication link, nonlinearity often occurs at the satellite's high power amplifier. Because the power available to the satellite is limited, it is desirable to transmit signals as efficiently as possible. As a result, in many cases, the amplifier on the satellite operates in an operating region with a nonlinear response because power is scarce. To improve efficiency and reception accuracy, the mapper in the transmitter (e.g., in a terrestrial gateway) and the demapper in receivers (e.g., terminals, such as very small aperture terminals (VSATs)) can be jointly optimized to use a symbol constellation that at least partially compensates for the nonlinearity. Various different types of demappers can be used in the receivers, but some options can include neural networks optimized through machine learning training to improve demapping accuracy.

On the return link from terminals to a gateway, the nonlinearity of the satellite's amplifier is less of an issue, because the gateway typically has a large antenna and moderate transmission power can be used so the satellite's amplifier operates more linearly. Nevertheless, the techniques for optimized constellations and improved mappers and demappers can still be used to improve performance, especially to account for the multiple amplifiers involved in transmission and reception. On return links, to minimize their cost and power consumption, user terminals will often operate their amplifiers as efficiently and cheaply as possible, and may use the smallest power amplifier and smallest power supply possible. The optimization techniques can improve a constellation and mapper or demapper to account for the nonlinearity of the transmitting terminal, as well as nonlinearity of the satellite's amplifier, to improve performance.

As discussed further below, the system can perform compensation of nonlinearity at a transmitter, at a receiver, or a combination of both. As an example, one challenge in wireless communications is that in transmission of a series of symbols, portions of the symbols in a sequence may be partially mixed. As a result, the receiver may detect signals that are a nonlinear function not only of the current symbol but also other symbols. Even if the nonlinearity itself is memoryless, transmit filters and receive filters can mix properties of neighboring symbols. To address this, a neural network, such as a convolutional neural network (CNN), can be trained and can receive and process a sequence of received symbols. As a result, the neural network can consider one or more samples for a symbol to be demapped along with other samples of other symbols in a window of time (e.g., a window of 5 symbols, 10 symbols, 20 symbols, etc.) which allows the neural network to perform receiver-based non-linearity compensation.

As another technique, predistortion compensation (e.g., digital predistortion (DPD)) can be performed at a transmitter to alter the signals that are transmitted to at least partially compensate for the distortion that will occur in the wireless channel. One option is to perform iterative predistortion compensation. For example, the system can start with an input vector representing data to transmit, such as a sequence of 100 symbols. The system can pass the sequence through a transmit filter with a model of the nonlinearity applied to obtain a distorted output. The system can subtract the desired output from the distorted output to obtain an error vector, then multiply the error by a constant, and subtract from the original input vector. With the correction applied, the output through the transmit path should result in a smaller error. The process can be performed iteratively to achieve smaller and smaller error to compensate for nonlinearity to a desired level before actual transmission.

In one general aspect, a communication device includes: a transmitter includes a mapper that has been iteratively trained through machine learning training based at least in part on demapper characteristics for a demapper of a receiver; where the mapper has parameter values that have been trained to at least partially compensate for non-linear distortion of signals in a wireless communication channel, including through application of non-linear distortion during training; and where the mapper is configured to map data to be transmitted to symbols in a symbol constellation for transmission, and wherein the parameter values of the mapper define characteristics of the symbol constellation including amplitude or phase of the symbols in the symbol constellation.

In some implementations, the parameter values of the mapper are determined through training using bit-wise mutual information or binary cross entropy as a loss function for the machine learning training of the mapper.

In some implementations, the mapper has been trained jointly with a demapper that is configured to convert in-phase and quadrature values for received signals to bit log likelihood ratios for received data.

In some implementations, the parameter values are parameter values of a neural network of the mapper.

In some implementations, the neural network comprises a single neural network layer.

In some implementations, the parameter values of the mapper are learned through joint training that adjusts parameter values of the demapper.

In some implementations, the parameter values of the mapper are learned parameters of an encoder in an autoencoder network; the parameter values of the demapper are learned parameters of a decoder in the autoencoder network; and the encoder and decoder of the autoencoder network have been trained with the non-linear distortion applied to samples indicative of output of the encoder before processing by the decoder.

In some implementations, the encoder and decoder are trained with output of the encoder being processed with a sample interpolator, the application of the nonlinear distortion to the interpolated samples, and the distorted samples processed with a sample decimator before being provided to the decoder.

In some implementations, the mapper has been trained based on characteristics of a bivariate demapper.

In some implementations, the mapper has been trained to learn parameter values jointly with learning of parameter values of a multi-layer neural network demapper.

In some implementations, the mapper has been trained to learn parameter values jointly with learning of parameter values of a convolutional neural network demapper.

In some implementations, the mapper has been trained to learn the parameter values while predistortion compensation is applied.

In some implementations, the mapper has parameter values that have been trained to at least partially compensate for nonlinearity of a satellite high power amplifier.

In some implementations, a combined nonlinearity resulting from nonlinearities of multiple amplifiers in a communication channel of a satellite networking system.

In some implementations, the mapper comprises multiple sets of parameter values, including sets of parameter values for each of: different modulation schemes; different ranges of signal quality; different types or levels of nonlinearity in wireless channels; or different types or levels of application of predistortion. The transmitter is configured to select one of the sets of parameter values to use for mapping data to symbols based on at least one of a modulation scheme to be used, a level of signal quality detected, a characteristics of a wireless channel being used, or a predistortion setting.

In some implementations, the communication device is a terrestrial satellite gateway, a satellite terminal, or a satellite.

In some implementations, the communication device comprises a receiver, wherein the receiver comprises a demapper trained through machine learning training that jointly learns parameter values of the demapper with and parameter values for a mapper for a corresponding transmitter.

In some implementations, the communication device comprises a receiver, wherein the receiver comprises a demapper that comprises a bivariate demapper, a multi-layer neural network, or a convolutional neural network.

In another general aspect, a communication device includes: a receiver includes a demapper that has been jointly trained with a mapper of a transmitter through machine learning training; wherein the demapper comprises a neural network that has parameter values trained to at least partially compensate for non-linear distortion of signals in a wireless communication channel, including through application of non-linear distortion during training; and wherein the demapper is configured to demap symbols of a symbol constellation learned through the machine learning training.

In some implementations, the parameter values of the demapper are determined through training using bit-wise mutual information or binary cross entropy as a loss function for the machine learning training of the mapper and the demapper.

In some implementations, the demapper is configured to convert in-phase and quadrature values for received signals to bit log likelihood ratios for received data.

In some implementations, the neural network is a convolutional neural network, and wherein the neural network is configured to receive input includes samples representing multiple transmitted symbols.

In some implementations, the demapper is trained to at least partially compensate for inter-symbol interference in transmission on the wireless communication channel.

In some implementations, the mapper has parameter values that have been trained to at least partially compensate for nonlinearity of a satellite high power amplifier.

In some implementations, the demapper comprises multiple sets of parameter values, including sets of parameter values for each of: different modulation schemes; different ranges of signal quality; different types or levels of nonlinearity in wireless channels; or different types or levels of application of predistortion. The receiver is configured to select one of the sets of parameter values to use for demapping transmitted symbols based on at least one of a modulation scheme to be used, a level of signal quality detected, a characteristics of a wireless channel being used, or a predistortion setting.

In some implementations, the communication device is a terrestrial satellite gateway, a satellite terminal, or a satellite.

In some implementations, the communication device comprises a transmitter, wherein the transmitter comprises a mapper that has been trained to compensate for nonlinear distortion.

In another general aspect, a system includes: a first communication device includes a transmitter that includes a mapper; and a second communication device includes a receiver that includes a demapper; where the mapper of the first communication device is configured to transmit data to the second communication device, and the mapper of the first communication device has been trained jointly with the demapper of the second communication device.

In some implementations, the first communication device is a satellite gateway and wherein the second communication device is a satellite terminal.

In some implementations, the first communication device is a satellite terminal and wherein the second communication device is a satellite gateway.

In another general aspect, a method includes: providing a series of input bits to a mapper includes a neural network; generating, using the neural network of the mapper, a set of output samples based on the series of input bits, wherein the set of output samples is indicative of symbols for transmission on a wireless communication channel; interpolating samples to increase a sample rate for the output samples; after the interpolation of the output samples, applying nonlinear distortion to the output samples; after applying the nonlinear distortion to the output samples, decimating the output samples; using a demapper to generate demapping output based on the decimated samples; calculating error of the demapping output with respect to the series of input bits using a loss function; and updating parameter values of the neural network of the mapper based on the calculated error.

In some implementations, the demapper comprises a second neural network; the demapping output is generated based on the second neural network; and the method includes updating parameter values of the second neural network based on the calculated error.

In some implementations, the method includes updating a demapper of one or more communication devices by providing the updated parameter values of the second neural network over a communication network to the one or more communication devices.

In some implementations, applying the nonlinear distortion comprises applying nonlinear distortion representative of a satellite high power amplifier.

In some implementations, the method includes updating a mapper of one or more communication devices by providing the updated parameter values of the neural network of the mapper or providing settings based on the updated parameter values of the neural network to the one or more communication devices over a communication network.

In another general aspect, a method includes: receiving signals with an antenna; determining in-phase and quadrature values for symbols of the received signals; processing the in-phase and quadrature values with a multi-layer neural network of a demapper, wherein the multi-layer neural network outputs bit log likelihood values for received data, and wherein the demapper comprises a neural network that has parameter values trained to at least partially compensate for non-linear distortion of signals in a wireless communication channel, including through application of non-linear distortion during training; and determining received bits based on the bit log likelihood values.

In some implementations, the method includes receiving updated parameter values for the demapper over a communication network, storing the received updated parameter values for the demapper, and receiving additional transmitted data using the updated parameter values for the demapper.

In another general aspect, a method includes: receiving bits to be transmitted over a wireless channel includes a nonlinearity; using a mapper to map the received bits to in-phase and quadrature values for symbols, wherein the mapper has parameter values that have been trained to at least partially compensate for non-linear distortion of signals in a wireless communication channel, including through application of non-linear distortion during training; generating a modulated signal based on the symbols mapped by the mapper; and transmitting the modulated signal over the wireless channel.

In some implementations, the method includes receiving updated parameter values for the mapper over a communication network, storing the received updated parameter values for the mapper, and transmitting data using the updated parameter values for the mapper.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for satellite network communication that uses jointly trained mapping and demapping.

FIG. 2 is a diagram showing an example of training of mapping and demapping that can account for nonlinearity of a wireless channel.

FIG. 3A is a diagram showing an example symbol constellation for 32APSK modulation.

FIG. 3B is a diagram showing an example result of optimizing the symbol constellation of FIG. 3A for a linear channel.

FIG. 4 is a chart showing capacity over a range of signal quality levels for the symbol constellations of FIGS. 3A-3B.

FIG. 5 is a chart showing block-level error rate (BLER) over a range of signal quality levels for the symbol constellations of FIGS. 3A-3B.

FIG. 6 is a chart showing an example of nonlinearity in a wireless channel.

FIG. 7 is a chart showing curves of signal quality with respect to output backoff for each of multiple different mapper and demapper combinations, for 32APSK in a nonlinear channel with the nonlinearity shown in FIG. 6.

FIG. 8 is a chart showing a comparison of spectra for different demapper options represented in FIG. 7.

FIG. 9A is a diagram showing an example symbol constellation for 64APSK modulation.

FIG. 9B is a diagram showing an example result of optimizing the symbol constellation of FIG. 9A for a linear channel.

FIG. 10 is a chart showing capacity over a range of signal quality levels for the symbol constellations of FIGS. 9A-9B.

FIG. 11 is a chart showing curves of signal quality with respect to output backoff for each of multiple different mapper and demapper combinations, for 64APSK in a nonlinear channel with the nonlinearity shown in FIG. 6.

Like reference numbers and designations in the various drawings indicate like elements.

### DETAILED DESCRIPTION

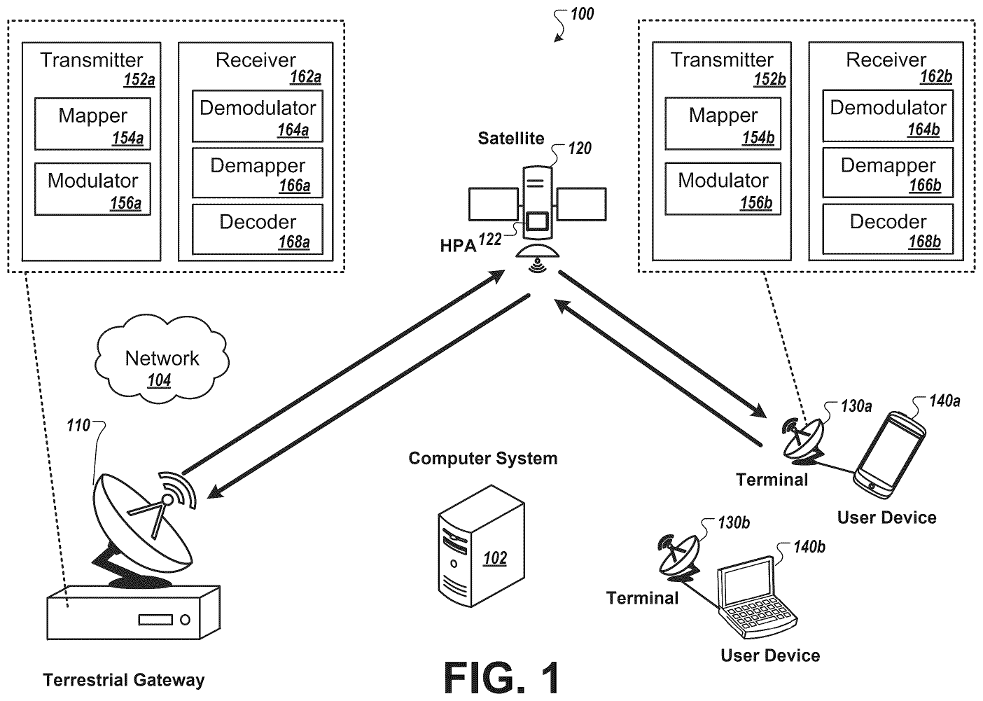

FIG. 1 is a diagram showing an example of a system 100 for satellite network communication that uses jointly trained mapping and demapping. The system includes a terrestrial gateway 110, a satellite 120, and satellite terminals 130a-130b (e.g., VSATs). The terrestrial gateway 110 is connected to a network 104, such as the Internet. The satellite communication infrastructure serves as a radio access network in which user devices 140a, 140b (e.g., phone, computer, television, etc.) are connected to the network 104. For example, each of the terminals 130a-130b provides one or more user devices 140a-140b bidirectional communication with the network 104, through the communication with the satellite 120 and the gateway 110.

The system 110 includes a computer system 102 that calculates optimized parameters for wireless communication. For example, the computer system 102 can use machine learning techniques to calculate parameter values for a mapper of a wireless transmitter and a demapper of a wireless receiver. The computer system 102 can train or optimize the mapper and demapper jointly, which can improve the power efficiency of transmission in the satellite network. In addition, the calculated parameters can improve improving the accuracy of reception and increase the information capacity of transmitted signals (e.g., by allowing the use of reduced forward error correction overhead). The processing of the computer system 102 can include calculation to generate or improve symbol constellation mappings, including optimizing for a particular signal quality range (e.g., a typical or desired operating range of Es/No, signal-to-noise ratio (SNR), signal-to-interference-and-noise ratio (SINR), etc.).

As discussed further below, the computer system 102 can perform processing to compensate for or account for nonlinearities in a wireless channel, such as nonlinearity of a high-power amplifier (HPA) 122 of the satellite. The computer system 102 can store data that characterizes noise and distortion in a wireless channel, including nonlinearities in the channel. The computer system 102 can then jointly optimize mapping between data to symbols (e.g., constellation design) and demapping of received signals (e.g., conversion of received complex symbol values to log-likelihood ratios (LLRs)). The computer system 102 can perform the joint optimization using training of one or more neural network layers using bit-wise mutual information (BMI). Although the resulting information can be stored or expressed in various ways, some implementations include at least one trained neural network layer in the demapper of the transmitter. Some implementations also use one or more trained neural network layers in the demapper. For example, the demapper can include a trained deep neural network or trained dense neural network. As another example, the demapper can include a trained convolutional neural network (CNN) configured to generate output based on windows of input representing multiple transmitted symbols in a sequence, which can compensate for and reduce the effects of inter-symbol interference (ISI) through the processing at the receiver. Other techniques are discussed below.

Modern digital communication systems are often based on bit-interleaved coded modulation (BICM) architectures, e.g., where bitwise interleaving is performed by binary encoder output prior to modulation symbol mapping. On the transmit side, after the FEC encoder, a mapper performs mapping of channel bits to modulated complex symbols. At the receive side, the received complex symbol values are demapped to bit log-likelihood (LLR) values. The mapping operation (equivalently, constellation design) can be optimized jointly with the demapping operation on a linear channel to increase capacity. These techniques can be used to increase capacity on non-linear channels, especially for high-power amplifiers (HPAs) typically employed on satellite transponders that are typically affected by gain compression (e.g., AM/AM conversion) and phase distortion (e.g., AM/PM conversion). These techniques can also be used with predistortion on the transmit side and also with a non-a-posteriori-probability (non-APP) demapper optimized for nonlinear channel operation.

In the example of FIG. 1, the gateway 110 includes a transmitter 152a and a receiver 162a, and the terminal 130a includes a transmitter 152b and a receiver 162b. The transmitters 152a, 152b each include a mapper 154a, 154b, and the receivers 162a, 162b each include a demapper 162b. For each direction of communication, the mapper and demapper can be jointly optimized to account for characteristics of the satellite's HPA 122 and potentially other sources of noise and distortion. This means that, for forward channel communication, the mapper 154a in the transmitter 152a of the gateway 110 can have parameter values or characteristics jointly trained with parameter values or characteristics of the demapper 166b in the receiver 162b of the terminal 130a. Similarly, for reverse channel communication, the mapper 154b in the transmitter 152b of the terminal 130b can have parameter values or characteristics jointly trained with parameter values or characteristics of the demapper 166a in the receiver 162a of the gateway 110.

The forward and reverse channels can have different characteristics, and may use different modulation schemes, and so different constellations and parameter values can be learned for each. In other words, the mapper 154a may use parameter values or constellations different from that of the mapper 154b, since each can be based on optimization for different conditions. In addition, each of the forward and reverse channels can experience a variety of different operating conditions (e.g., signal quality levels, types of interference, etc.), and may use different modulation schemes or operate in differing signal quality conditions at different times. As a result, each mapper and demapper can include multiple sets of parameter values to be used for different modulation schemes. Even for a single modulation scheme, different sets of parameter values can be stored for different signal quality ranges. The mappers and demappers can each select from among their stored sets of parameter values (which may include different neural networks or neural network training states) to choose the parameter values that are most appropriate for the selected modulation scheme and current wireless channel conditions.

In the example of FIG. 1, the gateway 110 includes a transmitter 152a that includes a mapper 154a and a modulator 156a. The mapper 154a receives input bits to be transmitted. In some cases, the bits to be mapped are a bitstream output by a FEC encoder that performs forward error correction coding. The system can use bit interleaving, such as by rearranging coded bits before modulation to ensure that errors affect dispersed bits rather than consecutive ones. The mapper 154a performs mapping by, for example, assigning the input bits (or groups of the input bits) to specific symbols in symbol constellation of a modulation scheme. For example, the mapper 154a can map binary data to complex in-phase/quadrature (I/Q) symbols for transmission. The mapper 154a can incorporate the symbol constellation optimizations determined by the computer system 102, which can include both the locations of symbols in the constellation as well as the labeling of bit sequences to the symbols. The mapper 154a can incorporate this constellation information through the parameter values of one or more trained neural network layers or in another form (e.g., look-up table, coordinates, equations or functions, etc.). The mapper outputs the I/Q values for the mapped symbols to the modulator 156a, which converts the symbols into modulated waveforms, such as a carrier wave modulated by the symbol data. The transmitter 152a can include various other components, such as filters, amplifiers, upconverters, and so on that are used in the process of transmitting data.

At the terminal, the receiver 162b includes a demodulator 164b, a demapper 166b, and a decoder 168b. In general, the demodulator 164b detects the phase, frequency, and/or amplitude changes in the received signal and provides the information to the demapper 166b. The demapper 166b then interprets the information from the demodulator 164b to determine which symbols are most likely present in the received signals. In some implementations, the demapper 166b is configured to output log-likelihood ratios (LLRs). For example, for each symbol received, the demapper 166b can output bit log-likelihood ratios for input to the decoder 168b. Other techniques can output likelihoods or measures for symbols. The output of the demodulator 164b can be processed by the decoder 168b to recover the bitstream of the originally transmitted data. The decoder 168b can be a FEC decoder that can, for example, identify error correction data such as parity data and detect or correct errors in the process of generating the recovered stream of data. The receiver 162b can include a variety of other components, such as amplifiers, filters, downconverters, and so on to process received signals and determine the data that was transmitted.

For reverse channel communication, the transmitter 152b uses a FEC encoder, a mapper 154b, and a modulator 156b for transmission using the same functions and techniques described for the transmitter 152a of the gateway 110. Similarly, the receiver 162a uses a demodulator 164a, a demapper 166a, and a decoder 168a using the same functions and techniques described for the receiver 162b of the terminal 130a.

In some implementations, the satellite 120 a transparent satellite is configured to retransmit the signals transmitted by the gateway 110 on the forward channel or from the terminals 130a-130b on the reverse channel. In other implementations, the satellite 120 can be a non-transparent satellite that has a regenerative payload that alters or enhances the received signal or generates a new signal based on the data in the signal the satellite 120 receives. In this case, the satellite 120 may also include a transmitter with a mapper and a receiver with a mapper, and these can parameters (e.g., a neural network) with parameter values learned through machine learning training.

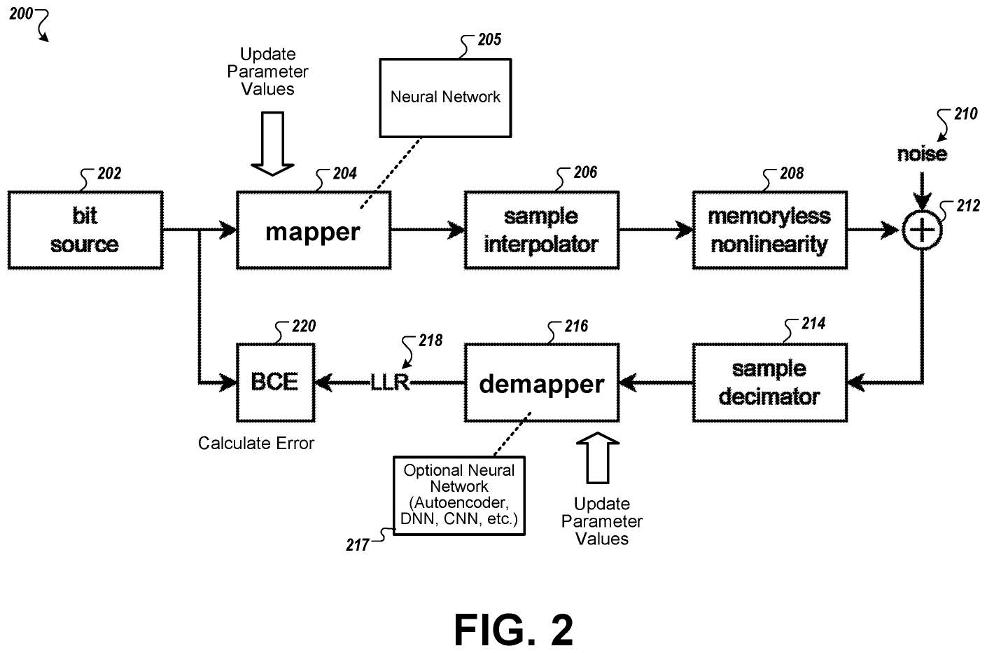

FIG. 2 is a diagram showing an example of training of mapping and demapping that can account for nonlinearity of a wireless channel. The example of FIG. 2 shows a process 200 that can be performed by the computer system 102 to update the parameter values used for mapping and demapping. After training, the parameter values that have been learned can be deployed to mappers and demappers so that gateways, terminals, and other communication devices can use the enhanced symbol constellations and demapping to benefit from the more efficient and more accurate communication.

The process 200 can achieve joint optimization of mapping (e.g., symbol constellation design and characteristics) and demapping (e.g., conversion of received complex symbol values to LLR or other indications of received data). The process 200 uses training on the bit-wise mutual information (BMI), which achieves joint optimization of constellation shaping and labeling together with demapping to bit log-likelihood ratios (LLR) for input to an FEC decoder.

Although various different mapper and demapper architectures can be used, one example uses a trained neural network for the transmitter's mapper and another trained neural network for the receiver's demapper. In some implementations, the mapper uses a single dense neural-network layer for the transmit mapper. In some implementations, the demapper uses a multi-layer dense neural network or a convolutional neural network.

The process 200 can include training using binary cross entropy (BCE) as the loss function. BCE is a convenient metric that is often available in many machine learning (ML) libraries and this is equivalent to maximizing BMI.

The process 200 includes the capability to model and compensate for nonlinearities that are often present in wireless channels used in satellite communications. For example, a satellite 120 often has a non-linear high power amplifier (HPA) that results in AM/AM distortion and AM/PM distortion. This is often a major source of nonlinearity in forward channel communication. This distortion, and potentially others, can be represented in the training process so that the mapper and demapper learn to account for the nonlinearity. This can include adjusting the symbol constellation, including (1) adjusting the symbol locations or spacings of symbols in the constellation and (2) adjusting the bit sequence labels of symbols to reduce potential for errors.

When performing training to optimize channels that are assumed to be linear, an autoencoder architecture can be used, with mapper including a neural network (e.g., an encoder) and the demapper including another neural network (e.g., a decoder). To account for non-linearity in the wireless channel, the example of FIG. 2 adds a sample interpolator, a nonlinearity function, and sample decimator between the mapper and the demapper, so that nonlinearity effect of a solid-state power amplifier (e.g., a satellite's high power amplifier, amplifier(s) in a terminal's transmitter, etc.) or other components can be represented and compensated for.

In many satellite systems, the cascade of transmit pulse shaping filter, memoryless nonlinearity, and receive matched filter introduces intersymbol interference (ISI). This ISI can be mitigated either by predistortion on the transmit side or by compensation techniques on the receive side. The process 200 can include training to compensate for ISI through processing on the receive side, such as by using a convolutional neural network (CNN) in the mapper to compute LLRs (or other indications of received data) based on windows of multiple received symbols. In addition, or as an alternative, the mapper and demapper optimization can be combined with transmit-side approaches to reduce the effects of ISI. For example, one transmit-side approach to the optimization of the mapper in nonlinear systems includes use of iterative symbol-level adjustment. For a lower complexity design, optimization can be performed for systems including a bivariate demapper.

In further detail, the example of FIG. 2 shows a bit source 202 that produces a sequence of bits. The generated bits are input to a mapper 204, which maps the bits to symbols, which can be represented by I/Q values. The mapper 204 includes a neural network 205, which can include one or more neural network layers. The symbol assignments and the symbol constellation can be set by the parameter values of the neural network 205. The symbols generated by the mapper 204 are provided to a sample interpolator 206, which outputs a sequence of samples that includes interpolated samples based on the output of the mapper 204. The sample interpolator 206 includes a root-raised cosine (RRC) pulse-shaping filter, because properly representing the nonlinearity effect of a solid-state power amplifier (SSPA) typically requires increasing the sample rate to multiple samples/symbol.

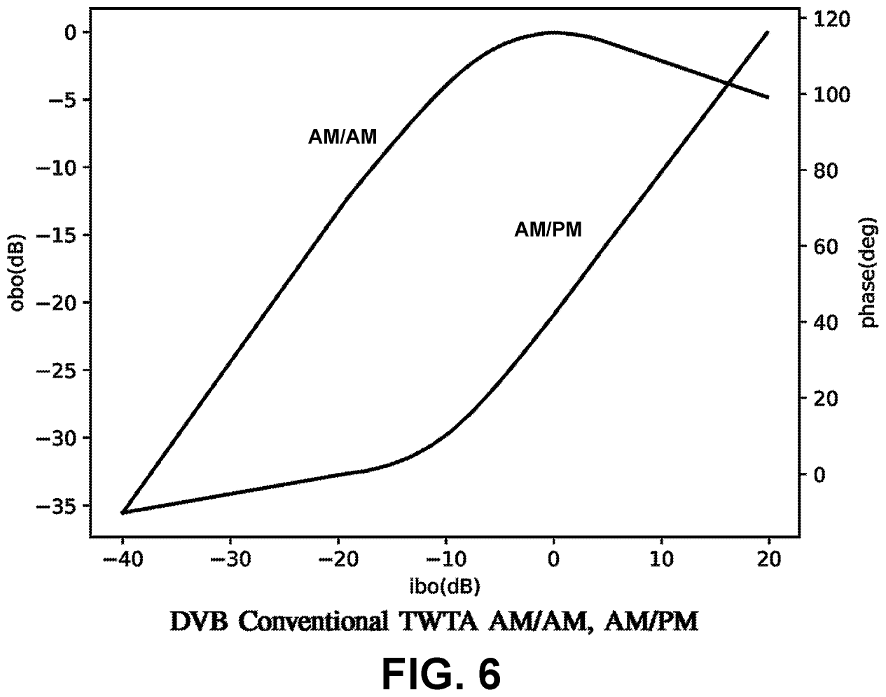

The sequence of samples is then subjected to a memoryless nonlinearity 208 that represents or models the nonlinearity experienced in the wireless channel. As an example, the nonlinearity 208 can be based on a traveling wave tube amplifier (TWTA) model, which is characterized by AM/AM distortion and AM/PM distortion shown in FIG. 6. TWTAs are widely used in satellite applications to provide signal power amplification at high frequencies. In addition, solid state power amplifiers (SSPAs) used mostly at S-band frequencies also exhibit performance characteristics similar to TWTAs. For example, for forward channel communications, the nonlinearity is often primarily a result of the HPA 122 of the satellite 120. For reverse channel communications, there may be additional nonlinear effects modeled, such as limitations of the transmitter and antenna of the transmitting terminal. On the reverse channel, user terminals often include small and inexpensive devices, which attempt to operate amplifiers as efficiently as possible with the smallest amplifier and smallest power supply. As a result, multiple amplifiers (including one or more amplifiers other than the satellite's HPA 122) can contribute to the distortion on the reverse channel, and the overall or cumulative effect can be modeled or represented by the nonlinearity 208. In general, any or all of the sources of distortion, including nonlinear distortion, in a wireless channel can be modeled and used in the optimization process 200. Because the process 200 represents end-to-end training from mapper to demapper, any wireless channel characteristics can be represented, and thus compensated for or accounted for, in the training of the mapper and demapper.

Although the example shows a memoryless nonlinearity 208, in some implementations, nonlinearity with memory (e.g., dependence on previous states or transmissions) may be modeled and compensated. To do this, a much larger set of input data may be used, to represent a wide variety of different bitstreams or symbol sequences. In addition, larger neural networks (e.g., with more neurons per layer or more layers) may be used, with input to the neural networks indicating a window of previous symbols, as well as larger numbers of training iterations.

After applying the nonlinearity 208, noise 210 is added with a adder 212 to more fully represent the properties of the wireless channel. The sequence of samples, now incorporating nonlinear distortion and noise, is provided to a sample decimator 214 which provides input to a demapper 216. The sample decimator 214 can include The include a root-raised cosine (RRC) pulse-shaping filter to decrease the sample rate and undo the upsampling of the sample interpolator 206.

There are several different types of demapper 216 that can be used. One example is a multi-layer deep neural network (e.g., with dense or fully-connected neural network). Another example is a convolutional neural network. Another example is a bivariate demapper, which treats the received signals as Gaussian random variables, and determines the centroid and other 2^{nd} order statistics for each constellation point. The training process 200 is performed with whichever demapper architecture is chosen, so the mapper 204 (and thus the symbol constellation) is optimized or adjusted to improve performance with the selected type of demapper. When the demapper 216 includes a neural network 217, such as a deep neural network or convolutional neural network, the parameter values (e.g., weights) of the neural network 217 are updated jointly with parameter values (e.g., weights) of the neural network 205 of the mapper 204. Different demapper options can use different sets of input features. For example, while some demapper options may consider samples representing a single transmitted symbol, other demapper options (such as a convolutional neural network) can receive and process a set of input samples a larger window to represent multiple transmitted symbols.

In the example of FIG. 2, the demapper 216 is configured to output bit log-likelihood ratios 218 indicating the likelihoods of different bits. Other systems can alternatively provide other types of demapper output, such as detected symbols, likelihoods for different symbols, detected bits, and so on. The type of output that the demapper 216 is configured to provide can be defined to match with the type of FEC decoder that is intended to be used in the system. A decoder is not illustrated in FIG. 2, but optionally can be included in the process, so that training accounts for the characteristics of the decoding or forward error correction techniques to be applied.

The computer system 102 uses the ground truth bits from the bit source 202 and the output of the demapper 216 to calculate error, such as BCE. Using the calculated error, the computer system 102 incrementally adjusts the parameter values of the neural network 205, and also the parameters of the neural network 217 if used, to reduce the error. The training process can include many iterative updates based on many different error calculations, each representing the end-to-end mapping and demapping of symbols, bits, bit sequences, etc. Because the data flow used for training applies the nonlinearity 208 of the channel being modeled, the parameter values for the mapper 204 and demapper 216 are updated to compensate for or mitigate the effects of the nonlinearity.

Neural networks can be trained by starting with randomly distributed weights. By choosing a single dense layer for the mapper 204 the system can actually initialize the mapping to a known good mapping rather than a random mapping. This is very helpful because otherwise, for large constellation sizes (e.g., 16 symbols, 32 symbols, 64 symbols, etc.) the probability that the optimization becomes stuck in a local optimal point becomes large. In the various examples below, the Digital Video Broadcasting-Satellite-Second Generation-extension (DVBS2x) constellations are used as initial starting points for optimization.

In some implementations, the process 200 includes an option to model the effects of predistortion compensation performed at a transmitter, so that the mapper and demapper parameter values are trained in the context of the predistortion that will be used. The training of the mapper 204 and demapper 216 in the process 200 can be used to further reduce the effects of nonlinearity, beyond the improvements made through predistortion.

The process 200 can be used to determine various different sets of parameter values that optimize for different modulations or conditions. For example, a separate set of mapper parameter values and demapper parameter values can be determined for each of different modulation schemes (e.g., QPSK, 16APSK, 32APSK, 64APSK, etc.). In addition, for each modulation scheme, a separate set of mapper parameter values and demapper parameter values for each of different signal quality ranges. For example, a first set of parameter values can be determined for 32APSK with energy per symbol to noise power spectral density ratio (Es/No) in the range from 9 to 10, a second set of parameter values can be determined for an Es/No range of 10 to 11, a third set of parameter values can be determined for an Es/No range of 11 to 12, and so on. Similarly, parameter values can be determined for ranges of different sizes (e.g., 9-11, 10-15, etc.). In addition, for a given modulation scheme and potentially a particular signal quality range, sets of parameter values can be determined for combinations or permutations of factors such as (1) different FEC settings, (2) different channel nonlinearities, (3) whether predistortion is applied or not, and other system configurations and channel conditions. Similarly, sets of parameters (for both mapper and corresponding demapper) can be determined for different power constraints or other operating characteristics of the system.

A transmitter, as discussed in FIG. 1, can include many different sets of mapper parameter values (e.g., neural network weights), and can be configured to select the appropriate set of parameter values for the modulation scheme, expected nonlinearity, signal quality range, and predistortion settings. Similarly, a receiver can include many different sets of demapper parameter values (e.g., neural network weights), and can also be configured to select the appropriate set of parameter values for the modulation scheme, expected nonlinearity, signal quality range, and predistortion settings (e.g., whether predistortion is used, the amount or type of predistortion, etc.).

In some implementations, the system 100 is configured to send updated parameter values for mappers and demappers over a communication network, to update the mappers and demappers of gateways, terminals, satellites, or other communication devices. For example, updates to the mapper or demapper of gateways can be sent over a network, and corresponding updates for the demapper or mapper of satellite terminals can be sent to the terminals, e.g., over multicast or broadcast. These updates can be used to improve mapper and demapper performance, including after the devices are deployed and in use. The updates learned through machine learning training, including new neural network parameter values or other settings, can similarly be used to expand capabilities of communication devices by adding support for additional modulations, and/or to provide optimization for various signal quality ranges, predistortion settings, types of nonlinearity expected or actually experienced on wireless channels, etc.

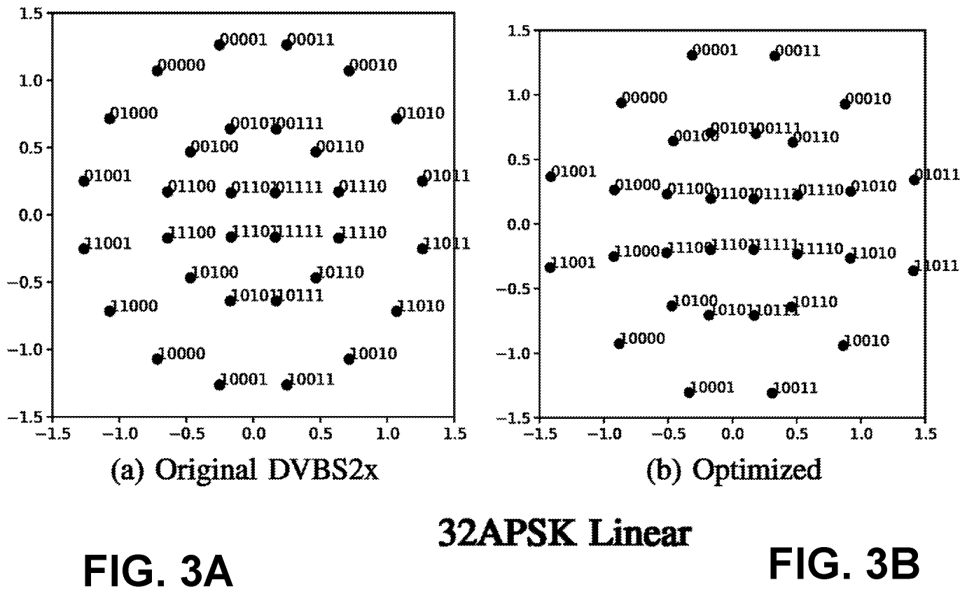

FIG. 3A is a diagram showing an example symbol constellation for 32APSK modulation. FIG. 3B is a diagram showing an example result of optimizing the symbol constellation of FIG. 3A for a linear channel. FIGS. 3A-3B illustrate an example of optimization applied to 32APSK from DVBS2x, using rate R=2/3 coding. In the example, 3gpp NR code is used, with the largest block size N=8400. The original constellation is shown in FIG. 3A while the optimized constellation is shown in FIG. 3B where the ‘original’ curve is for the DVBS2x constellation and ‘optimized 11-12’ is the constellation optimized over the range of Es/No=[11 . . . 12] dB.

A comparison of FIGS. 3A-3B shows that the optimized constellation of FIG. 3B has many significant differences from that of the original constellation of FIG. 3A, especially in the locations of the points that represent symbols. For example, the overall arrangement in FIG. 3A shows four points in the middle, surrounded by a circular ring of 12 points, and an outer circular ring of 16 points. In the rings, the points are substantially equally spaced along a circle.

The optimized constellation of FIG. 3B shows a somewhat different arrangement. There are still four points near the center, and two rings, but the rings have different characteristics. The outer ring has 12 points, and the middle ring has 12 points, with another 4 points being placed within the middle ring, e.g., two to the right and two to the left of the central four points. Neither the middle ring nor the outer ring is precisely circular, and the spacing between points along each ring. For example, in the middle ring, the four points at the bottom and top of the ring are more closely spaced together than the points along the right and left sides of the ring. In addition, the shape of the outer ring is not fully round, such as in the upper left corner where the point for bit sequence 00000 is closer to the center than would be the case for placing the points along a circle. These differences and others in the arrangement of symbols in constellations (e.g., the I/Q values for each symbol set by the mapper) can be determined through machine learning training to improve capacity and efficiency of communication.

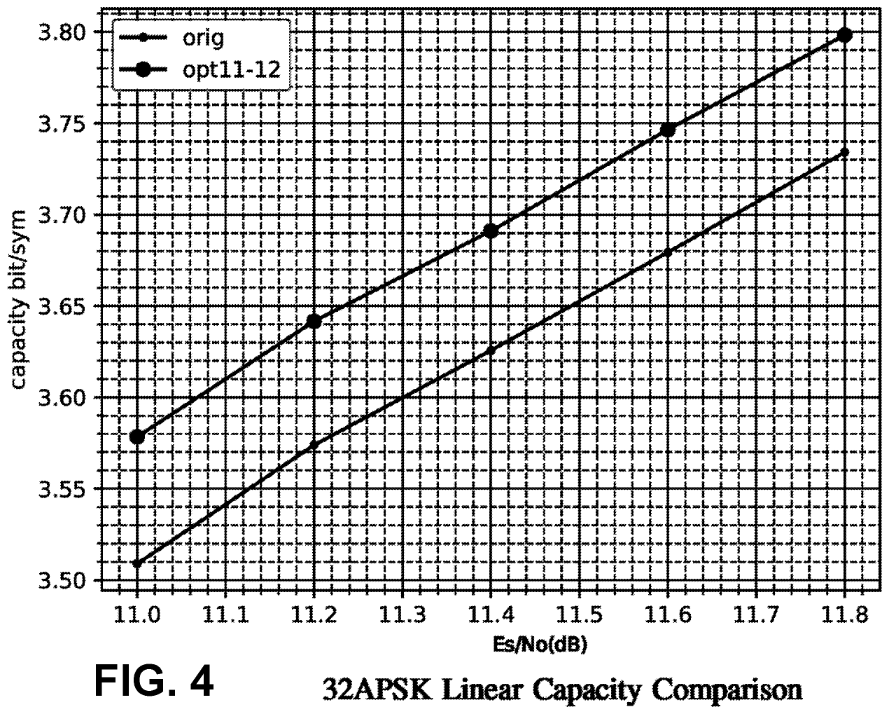

FIG. 4 is a chart showing capacity over a range of signal quality levels for the symbol constellations of FIGS. 3A-3B. This shows an improvement in pragmatic capacity, e.g., bits per symbol of user data transferred, which shows an improvement of about 0.25 dB at 11.4 dB Es/No.

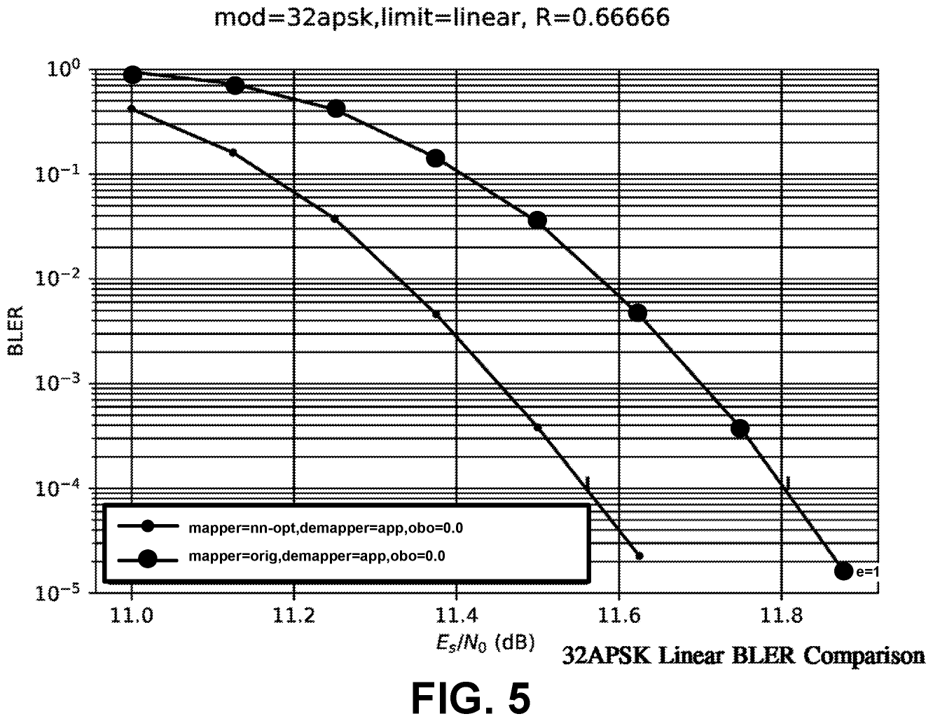

FIG. 5 is a chart showing block-level error rate (BLER) over a range of signal quality levels for the symbol constellations of FIGS. 3A-3B. This simulation result confirms the improvement in channel capacity shown in FIG. 4.

FIG. 6 is a chart showing an example of nonlinearity in a wireless channel. The nonlinearity shown is a TWTA model, which includes AM/AM distortion and AM/PM distortion. In addition, solid state power amplifiers (SSPAs) exhibit performance characteristics similar to TWTAs in various frequency ranges.

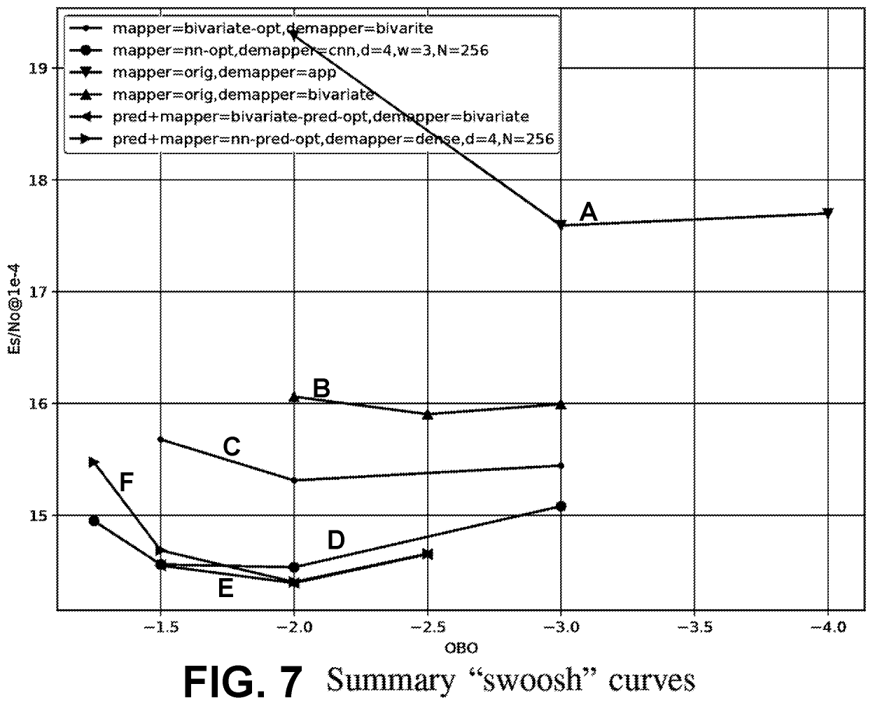

FIG. 7 is a chart showing curves of signal quality with respect to output backoff for each of multiple different mapper and demapper combinations, for 32APSK in a nonlinear channel with the nonlinearity shown in FIG. 6. FIG. 7 shows simulation results for each of different mapper and demapper combinations, including for various combinations optimized for the non-linearity using the process 200 shown in FIG. 2.

A variety of demapper approaches can be used for the nonlinear channel. The original DVBS2x constellation at the transmitter with a receiver that implements an ideal automatic gain control (AGC) function and LLRs produced by a posteriori probability (APP) demapper with respect to the original constellation (FIG. 3A) is considered as a baseline, which represents an ideal transmitter and receiver that ignores the nonlinear channel effect (other than finding the closest linear mapping of the received constellation to the transmit constellation). This case is labeled “mapper=orig, demapper=app” in subsequent results, and is shown with curve labeled “A” in FIG. 7.

A second option also uses the original transmit mapper (e.g., original symbol constellation) but uses a bivariate Gaussian technique to compute the LLRs. Here the receive probability density functions (PDFs) for each constellation point are approximated as 2D Gaussian. This case is identified here as “mapper=orig, demapper=bivariate,” and is labeled as curve “B.”

Another approach is to use a bivariate demapper on the receive side, but optimize the mapper using the bivariate demapper, using the bivariate demapper during the training of the mapper. This approach is labeled here as “mapper=bivariate−opt, demapper=bivariate,” labeled as curve “C.”

As mentioned above, the cascade of pulse shaping filter, nonlinearity, and receive matched filter introduces ISI. One way to mitigate this ISI on the receive side is to use a demapper based on a Convolutional Neural Net (CNN) which provides a way to include the memory effect in the optimization of the demapper. In this case the mapper and demapper are jointly optimized and are labeled here as “mapper=nn−opt, demapper=cnn,d=x,w=y,N=z” where x, y, z indicate the depth, width, and size of the CNN used. An example curve for a CNN with depth of 4, width of 3, and size 256 is labeled as curve “D.”

A further approach is to jointly train a mapper with the CNN demapper, but then employ an APP demapper in simulation. This achieves some optimization of the transmit constellation for the nonlinear channel without changing the receiver structure. This case might be of interest where the receiver cannot be changed or must have minimal complexity, even though performance will suffer due to the mismatched receiver. This case is not illustrated.

It is possible to mitigate the ISI at the transmit side instead of the receive side. One approach to implement this is the iterative predistortion technique. In this case different receive demappers can be considered. One possible architecture is using the bivariate demapper. Here we have jointly optimized the end-to-end system including predistortion and bivariate demapper, and this case is labeled as “pred+mapper=bivariate−pred−opt, demapper=bivariate,” and the curve is labeled “E.” This curve is slightly under curve F from −1.5 to −2.0 and substantially overlaps with curve F from −2.0 to −2.5.

A final case is also based on use of the iterative predistortion but this time using a NN demapper. Since ISI has been mitigated at the transmitter, there is no need for a CNN at the receiver and instead a dense NN is used for the demapper. This case is labeled as “pred+mapper=nn−pred—opt, demapper=dense,d=x,N=z” where d, N designate the depth and size of the dense NN used. A curve for the example with depth of 4 and size of 256 is labeled “F.”

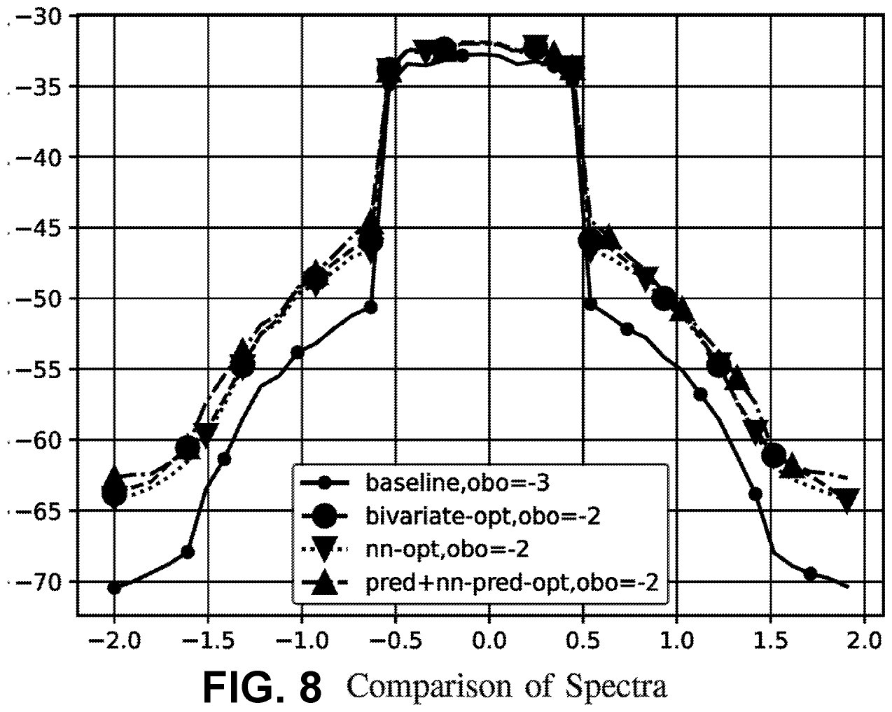

FIG. 8 is a chart showing a comparison of spectra for different demapper options represented in FIG. 7. One tradeoff is that increases to the transmit output backoff (OBO), while improving noise performance when combined with the techniques considered here, will increase the out-of-band spectral regrowth in the SSPA. To illustrate FIG. 8 shows the spectra of several cases, including: (1) the “baseline” case, e.g., original constellation with APP demapper, at −3 dB OBO, (2) “nn−opt,” e.g., trained neural-network mapper and trained CNN demapper, at −2 dB OBO, (3) “mapper=bivariate−opt,” e.g., mapper trained with nonlinearity and a bivariate demapper, at −2 dB OBO. These are cases use the respective optimal OBO settings for those cases from FIG. 7 not including the use of predistortion. Also the case of predistortion with optimized mapping and dense NN demapping “pred+mapper=nn−pred−opt” operating at −2 dB OBO is included, which represents an optimal OBO for this case in terms of noise performance.

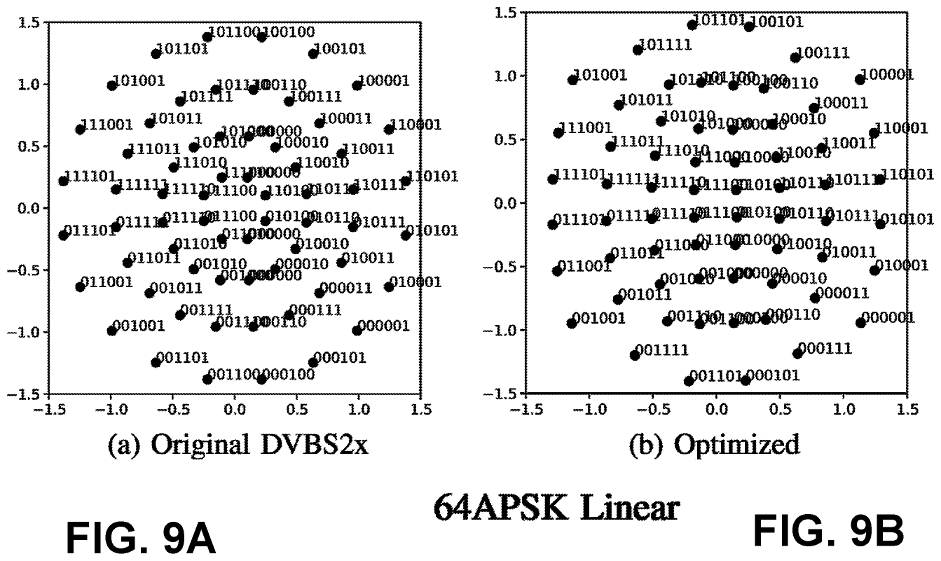

FIG. 9A is a diagram showing an example symbol constellation for 64APSK modulation. FIG. 9B is a diagram showing an example result of optimizing the symbol constellation of FIG. 9A for a linear channel. The same techniques for optimizing the 32APSK mapper and demapper can also be applied to other symbol constellations, such as 64APSK. In the examples of FIG. 9A-9B, 64APSK with code rate 3/4 is shown. The figures compare the original DVBS2x 64APSK constellation (FIG. 9A) with the optimized constellation (FIG. 9B).

The optimized constellation of FIG. 9B shows various differences from the original constellation of FIG. 9A, including both the locations of the points that represent symbols as well as the bit sequences that are assigned to the points. For example, the original constellation shows four concentric rings of points, with each of the four rings being substantially circular. The optimized constellation has an outer ring of points and an intermediate ring of points within, but the shapes are somewhat oval-shaped. In addition, the central region is arranged as four curved columns of points rather than concentric circles. The spacing among points is also changed in the optimized constellation. In addition, the bit sequence labelling is different for the symbols in the two constellations. For example, the top two points in FIG. 9A are labelled 101100 and 100100, while the top two points in FIG. 9B are labeled 101101 and 100101. The adjusted labeling can also be determined through machine learning training, to select bit sequence labels that enhance reception and best fit the symbol locations learned through the training.

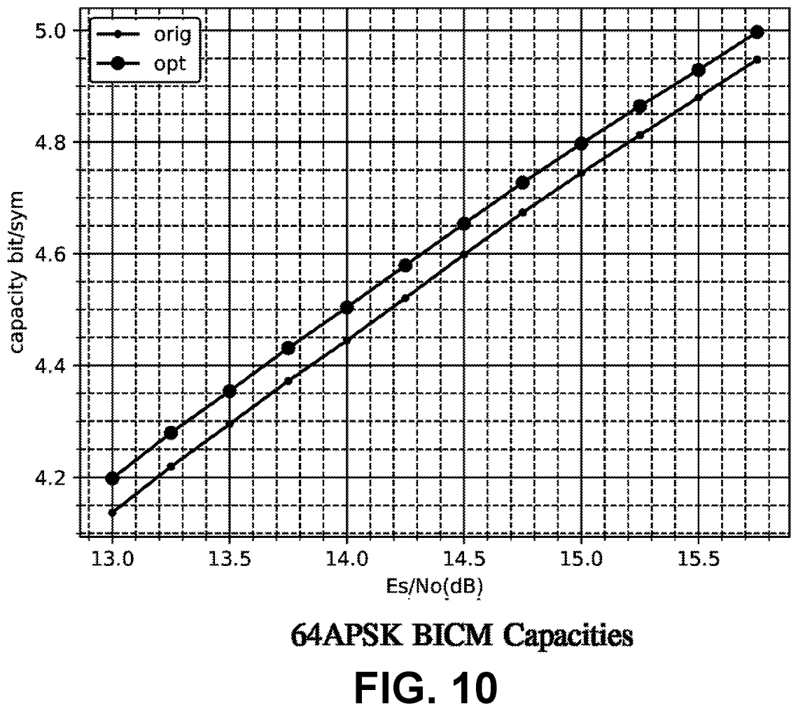

FIG. 10 is a chart showing capacity over a range of signal quality levels for the symbol constellations of FIGS. 9A-9B. The figure shows BICM capacities of the constellations of FIGS. 9A-9B, which shows an improvement of about 0.2 dB.

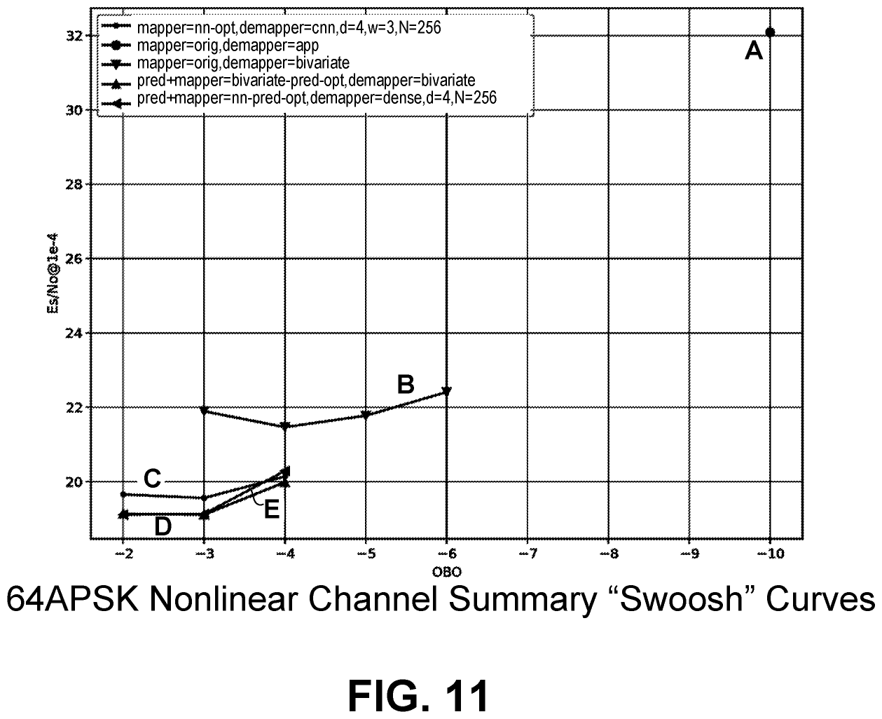

FIG. 11 is a chart showing curves of signal quality with respect to output backoff for each of multiple different mapper and demapper combinations, for 64APSK in a nonlinear channel with the nonlinearity shown in FIG. 6. Similar to optimization of 32APSK for a nonlinear channel above, optimization of 64APSK for the same DVB TWTA model.

Without nonlinear compensation, 64APSK is almost unusable on the nonlinear channel, as shown by the single point (labeled “A”) at −10 dB OBO (mapper=orig,demapper=app).

Using the same original DVBS2x transmit constellation (FIG. 9A) with a bivariate demapper provides a large improvement (mapper=orig,demapper=bivariate), with the curve labeled “B.”

An optimized mapper coupled with a CNN demapper offers further improvement and ability to run with higher power (OBO) (mapper=nn−opt,demap−per=cnn,d=4,w=3,N=256), labeled curve “C.”

Adding iterative predistortion shows a small additional improvement. Iterative distortion is considered both with (1) bivariate demapper (pred+mapper=bivariate−pred−opt, demapper=bivariate), labeled curve “D,” and (2) a dense NN demapper (pred+mapper=nn−pred−opt,demapper=dense,d=4,N=256), labeled curve “E,” both showing similar performance and substantially overlapping from −2 to −3. The similarity suggests that, when trained with distortion compensation applied by the transmitter, the NN learned the bivariate demapping or a very similar demapping.

In the simulated cases, there is considerable room for performance optimization compared to the baseline cases. For example, the existing SOA DVBS2x 32APSK constellation can be modified to obtain increased capacity on the linear channel through the optimization of BCE. Similarly, optimization of the DVBS2x 64APSK constellation on a linear channel also achieves increased capacity.

On the nonlinear channel, characterized by the example TWTA, a variety of techniques are demonstrated to optimize mapping and demapping. Even when considering the use of an advanced receiver demapping technique (bivariate), substantial performance improvements are demonstrated when jointly optimizing the mapping together with demapping.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A communication device comprising:
a transmitter comprising a mapper that has been iteratively trained through machine learning training based at least in part on demapper characteristics for a demapper of a receiver;
wherein the mapper has parameter values that have been trained to at least partially compensate for non-linear distortion of signals in a wireless communication channel, including through application of non-linear distortion during training; and
wherein the mapper is configured to map data to be transmitted to symbols in a symbol constellation for transmission, and wherein the parameter values of the mapper define characteristics of the symbol constellation including amplitude or phase of the symbols in the symbol constellation.

2. The communication device of claim 1, wherein the parameter values of the mapper are determined through training using bit-wise mutual information or binary cross entropy as a loss function for the machine learning training of the mapper.

3. The communication device of claim 1, wherein the mapper has been trained jointly with a demapper that is configured to convert in-phase and quadrature values for received signals to bit log likelihood ratios for received data.

4. The communication device of claim 1, wherein the parameter values are parameter values of a neural network of the mapper.

5. The communication device of claim 4, wherein the neural network comprises a single neural network layer.

6. The communication device of claim 1, wherein the parameter values of the mapper are learned through joint training that adjusts parameter values of the demapper.

7. The communication device of claim 6, wherein the parameter values of the mapper are learned parameters of an encoder in an autoencoder network;
wherein the parameter values of the demapper are learned parameters of a decoder in the autoencoder network; and
wherein the encoder and decoder of the autoencoder network have been trained with the non-linear distortion applied to samples indicative of output of the encoder before processing by the decoder.

8. The communication device of claim 7, wherein the encoder and decoder are trained with output of the encoder being processed with a sample interpolator, the application of the nonlinear distortion to the interpolated samples, and the distorted samples processed with a sample decimator before being provided to the decoder.

9. The communication device of claim 1, wherein:
the mapper has been trained based on characteristics of a bivariate demapper;
the mapper has been trained to learn parameter values jointly with learning of parameter values of a multi-layer neural network demapper; or
the mapper has been trained to learn parameter values jointly with learning of parameter values of a convolutional neural network demapper.

10. The communication device of claim 1, wherein the mapper has been trained to learn the parameter values while predistortion compensation is applied.

11. The communication device of claim 1, wherein the mapper has parameter values that have been trained to at least partially compensate for nonlinearity of a satellite high power amplifier.

12. The communication device of claim 1, wherein the mapper comprises multiple sets of parameter values, including sets of parameter values for at least one of:
different modulation schemes;
different ranges of signal quality;
different types or levels of nonlinearity in wireless channels; or
different types or levels of application of predistortion;
wherein the transmitter is configured to select one of the sets of parameter values to use for mapping data to symbols based on at least one of a modulation scheme to be used, a level of signal quality detected, a characteristics of a wireless channel being used, or a predistortion setting.

13. A communication device comprising:
a receiver comprising a demapper that has been jointly trained with a mapper of a transmitter through machine learning training;
wherein the demapper comprises a neural network that has parameter values trained to at least partially compensate for non-linear distortion of signals in a wireless communication channel, including through application of non-linear distortion during training; and
wherein the demapper is configured to demap symbols of a symbol constellation learned through the machine learning training.

14. The communication device of claim 13, wherein the parameter values of the demapper are determined through training using bit-wise mutual information or binary cross entropy as a loss function for the machine learning training of the mapper and the demapper.

15. The communication device of claim 13, wherein the demapper is configured to convert in-phase and quadrature values for received signals to bit log likelihood ratios for received data.

16. The communication device of claim 13, wherein the neural network is a convolutional neural network, and wherein the neural network is configured to receive input comprising samples representing multiple transmitted symbols.

17. The communication device of claim 13, wherein the demapper is trained to at least partially compensate for inter-symbol interference in transmission on the wireless communication channel.

18. The communication device of claim 13, wherein the mapper has parameter values that have been trained to at least partially compensate for nonlinearity of a satellite high power amplifier.

19. The communication device of claim 1, wherein the demapper comprises multiple sets of parameter values, including sets of parameter values for at least one of:
different modulation schemes;
different ranges of signal quality;
different types or levels of nonlinearity in wireless channels; or
different types or levels of application of predistortion;
wherein the receiver is configured to select one of the sets of parameter values to use for demapping transmitted symbols based on at least one of a modulation scheme to be used, a level of signal quality detected, a characteristics of a wireless channel being used, or a predistortion setting.

20. A method comprising:
providing a series of input bits to a mapper comprising a neural network;
generating, using the neural network of the mapper, a set of output samples based on the series of input bits, wherein the set of output samples is indicative of symbols for transmission on a wireless communication channel;
interpolating samples to increase a sample rate for the output samples;
after the interpolation of the output samples, applying nonlinear distortion to the output samples;
after applying the nonlinear distortion to the output samples, decimating the output samples;
using a demapper to generate demapping output based on the decimated samples;
calculating error of the demapping output with respect to the series of input bits using a loss function; and
updating parameter values of the neural network of the mapper based on the calculated error.
